(19) United States
(12) Patent Application Publication
(10) Pub. No.: US 2022/0300362 A1
(43) Pub. Date: Sep. 22, 2022

(54) DISTRIBUTED SYSTEM AND DIAGNOSTIC METHOD

(71) Applicant: Hitachi, Ltd., Tokyo (JP)

(72) Inventors: Tadanobu TOBA, Tokyo (JP); Kenichi SHIMBO, Tokyo (JP); Yutaka UEMATSU, Tokyo (JP); Takumi UEZONO, Tokyo (JP); Hidetoshi TERAOKA, Tokyo (JP)

(21) Appl. No.: 17/539,279

(22) Filed: Dec. 1, 2021

(30) Foreign Application Priority Data
Mar. 22, 2021 (JP) 2021-047876

(51) Int. Cl. G06F 11/00; G06F 11/26; G07C 5/00

(52) U.S. Cl. CPC G06F 11/006; G06F 11/26; G07C 5/008; G06F 2201/805

(57) ABSTRACT

A distributed system includes an edge system as an automatically operable moving body or equipment and a diagnostic data computer capable of communicating with the edge system. The edge system has a mechanism unit for operation, an in-edge controller controlling the mechanism unit, and a diagnostic controller capable of communicating with the in-edge controller via an in-vehicle network. The diagnostic controller acquires diagnostic data in accordance with a first diagnostic sequence set and transmits the diagnostic data to the diagnostic data computer. The diagnostic data computer transmits a diagnostic update notification of update to a second diagnostic sequence set to the diagnostic controller based on the diagnostic data. The diagnostic controller performs update from the first diagnostic sequence set to the second diagnostic sequence set.

### CROSS-REFERENCE TO RELATED APPLICATION

The present application claims priority from Japanese application JP2021-047876 filed on Mar. 22, 2021, the contents of which is hereby incorporated by reference into this application.

### BACKGROUND OF THE INVENTION

### 1. Field of the Invention

The present disclosure relates to a technique with which an edge system such as a vehicle is diagnosed.

### 2. Description of Related Art

JP-A-2014-517378 (Patent Document 1) discloses a system diagnosing a vehicle as an edge system. According to the disclosure, the system has a server and a diagnostic device mounted in the vehicle, a diagnostic script is sent from the server to the vehicle, and the diagnostic device in the vehicle executes diagnosis in accordance with the diagnostic script with the diagnostic script received. The diagnostic script is generated by a script generation device. The script generation device creates a platform-independent script. Preferably, this script is a combination of an OTX script and ODX-control device-diagnostic data.

### SUMMARY OF THE INVENTION

Patent Document 1 does not consider improving the quality of the diagnostic script-based diagnosis itself. In the method of Patent Document 1, the diagnostic device mounted in the vehicle is connected to a sensor and is also responsible for acquiring sensor data measured by the sensor. Accordingly, both the load of the processing of acquiring the sensor data measured by the sensor and the load of the processing of executing the diagnosis in accordance with the diagnostic script are applied to the diagnostic device. There was a possibility that a heavy load on the diagnostic device affects one or both of the data acquisition and the execution of the diagnosis.

An object of the present disclosure is to provide a technique with which the quality of diagnosis can be improved and the load on an in-vehicle device can be reduced.

A distributed system according to one aspect of the present disclosure includes: an edge system as an automatically operable moving body or equipment; and a diagnostic data computer capable of communicating with the edge system, in which the edge system has a mechanism unit for operation, an in-edge controller controlling the mechanism unit, and a diagnostic controller capable of communicating with the in-edge controller via an in-vehicle network, the diagnostic controller: acquires diagnostic data in accordance with a first diagnostic sequence set indicating a procedure in which the in-edge controller is diagnosed by one or more diagnostic sequences defining an information type and a timing acquired as diagnostic data indicating an internal state of the in-edge controller, and transmits the acquired diagnostic data to the diagnostic data computer, the diagnostic data computer: determines an information type and a timing to be acquired as diagnostic data from the in-edge controller based on the received diagnostic data, and transmits a diagnostic update notification of update to a second diagnostic sequence set including a diagnostic sequence defining the determined information type and timing to the diagnostic controller, and the diagnostic controller: performs update from the first diagnostic sequence set to the second diagnostic sequence set, acquires diagnostic data in accordance with the second diagnostic sequence set, and transmits the acquired diagnostic data to the diagnostic data computer.

According to one aspect of the present disclosure, the quality of diagnosis can be improved and the load on an in-vehicle device can be reduced.

### BRIEF DESCRIPTION OF THE DRAWINGS

FIG. 1 is a block diagram of a distributed system according to Example 1;

FIG. 2 is a diagram illustrating the data configuration of a sequence memory in Example 1;

FIG. 3 is a sequence diagram illustrating the flow of the processing of updating a diagnostic sequence set in Example 1;

FIG. 4 is a diagram illustrating an example of the hardware configuration of a computer configured in a server;

FIG. 5 is a block diagram of a distributed system according to Example 2; and

FIG. 6 is a diagram illustrating the data configuration of a sequence memory in Example 2.

### DESCRIPTION OF EMBODIMENTS

The following embodiment will be described after division into a plurality of sections or embodiments when the division is necessary for convenience. Unless otherwise specified, those are mutually related and one is related to, for example, a modification example, details, or supplementary description as to a part of another or another as a whole.

In a case where an element count or the like (including, for example, number, numerical value, quantity, and range) is referred to in the following embodiment, the element is not limited to the specific count and may be equal to or more than or equal to or less than the specific count unless, for example, otherwise specified or the element is obviously limited to the specific count in principle.

As a matter of course, components of the following embodiment (including element steps and the like) are not necessarily essential unless, for example, otherwise specified or obviously considered essential in principle.

When the shape, positional relationship, and the like of, for example, a component are referred to in the following embodiment, those that are, for example, substantially approximate or similar to the shape and the like are included unless, for example, otherwise specified or it is obviously conceivable in principle that this is not the case. This also applies to the above numerical values and ranges.

In principle, the same members are given the same reference numerals, with redundant descriptions omitted, in all the drawings for describing the embodiment.

An aspect in which a cloud server realizes various servers will be exemplified for simplification of the following description. The various servers may be represented by a computer in part or in whole.

Hereinafter, examples will be described.

### Example 1

### <System Configuration>

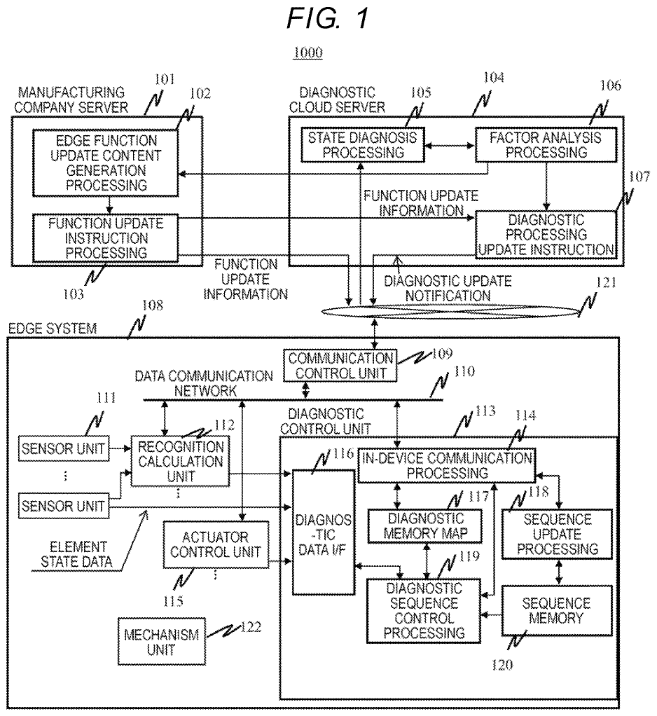

FIG. 1 is a block diagram of a distributed system according to Example 1.

A distributed system 1000 has a manufacturing company server 101, a diagnostic cloud server 104, and an edge system 108.

The edge system 108 is an automatically operable moving body or equipment and is a device to be diagnosed by the distributed system 1000. Details of the edge system 108 will be described later.

The diagnostic cloud server 104 is built on the cloud and capable of communicating with the edge system 108 via a communication network 121. The diagnostic cloud server 104 is a diagnostic data computer collecting diagnostic data of the edge system 108. Details of the diagnostic cloud server 104 will be described later.

The manufacturing company server 101 is a computer of a company designing or manufacturing the edge system 108 and is capable of operating in cooperation with the diagnostic cloud server 104 by communication. Details of the manufacturing company server 101 will be described later.

### <Edge System>

It is conceivable that the edge system 108 is, for example, a moving body (such as a vehicle, a drone, and a robot) or equipment (such as a robot arm, a machine tool, and a numerical control lathe) that can be automatically operated. Automatic driving is an example of being “automatically operated”. The edge system 108 is not limited to a device manufactured by the same company and includes multiple generations and types of devices. The edge system 108 is not limited to either a moving body or equipment and may serve as both.

The edge system 108 has a mechanism unit 122, which is a moving mechanism (for example, an engine or a motor in the case of a moving body) or an operating mechanism (for example, an actuator such as motor and hydraulic actuators in the case of equipment). Here, “operation” means at least “device changing state in accordance with operated command by performing certain operation (JIS B 0132-compliant)”. In the following description, a case where the edge system 108 is a moving body will be representatively described as a simplification of the description.

Conceivable if the mechanism unit 122 is a moving mechanism is, for example, a force-generating or force-suppressing component such as an actuator (for example, motor and hydraulic actuators), a brake, and a motor as well as a force transmission structure such as a wheel, a vehicle wheel, a shaft, a belt, and a gear. The mechanism unit 122 may be another mechanism.

The edge system 108 has a communication control unit 109, a data communication network 110, sensor units 111, a recognition calculation unit 112, a diagnostic control unit 113, and an actuator control unit 115.

The communication control unit 109 is a communication device that is connected to the data communication network 110 in the edge system 108, can be connected to the communication network 121, and enables communication with an external device by a device in the edge system 108. The communication with the external device by the communication control unit 109 is typically realized by a wireless communication module (such as a Wi-Fi (registered trademark) module and a 5G communication module). The wireless communication module does not necessarily have to be included in each component of the edge system 108. Alternatively, the edge system 108 may include a gateway device having a wireless communication module (such as an ECU, a smartphone, and a wireless router) and communication processing in relation to the outside may be centralized in the gateway device.

The data communication network 110 is an in-vehicle network connected to the recognition calculation unit 112, the actuator control unit 115, and the diagnostic control unit 113 in the edge system 108 and transmitting data in the edge system 108.

The sensor units 111 are sensors measuring various types of data (for example, speed, temperature, and current position) and outputting the data as electric signals. Conceivable examples of the sensor units 111 include devices such as a GPS, a fuel system, a speedometer, a tachometer (for a motor, an engine, and a wheel), a distance meter (such as a distance meter using light detection and ranging (LiDAR) or ultrasonic waves), a position or displacement sensor, and an angle detection sensor.

The recognition calculation unit 112 and the actuator control unit 115 are in-edge controllers. The recognition calculation unit 112 recognizes the electric signal output from the sensor unit 111 and converts the signal into state information. The actuator control unit 115 controls actuators (not illustrated) arranged in the respective units of the edge system 108 including the mechanism unit 122 based on the state information acquired by the recognition calculation unit 112. By operating the in-edge controller, the state of the hardware configured in the edge system 108 including the mechanism unit 122 and the sensor unit 111 is stored as the internal state of the in-edge controller. Examples of the in-edge controller include a vehicular electronic controller unit (ECU), a drone controller, a programmable logic controller (PLC) in an industrial field, and an NC controller of a machine tool.

In a case where the edge system 108 is a vehicle and the in-edge controller is an ECU, the edge system 108 may include a plurality of in-edge controllers playing different roles respectively (lane keeping, inter-vehicle distance control, engine speed control, control of communication with the outside of an edge device 12). The plurality of roles may be assigned to a common in-edge controller. In the automotive industry, such a role is sometimes referred to as “function” or “system function”. How to have such a role may be applied in a case where the in-edge controller is not an ECU.

It is conceivable that the hardware configured in the in-edge controller is, for example, a central processing unit (CPU), a graphics processing unit (GPU), an application specific integrated circuit (ASIC) for data processing, a bus, and a sensor. The hardware does not necessarily need all the components.

The in-edge controller is realized by a software program (hereinafter, sometimes referred to as a control program) being executed by the hardware configured in the in-edge controller. In the case of an in-edge controller that has the role of speed maintenance, the control program is a program executing the processing of transmitting an engine throttle opening and closing instruction and a motor acceleration and deceleration instruction while performing comparison between the speed measured by a speedometer as one of the sensor units 111 (sensor data) and a designated speed. The control program may be installed, updated, or parameter-updated by data received by the in-edge controller.

The in-edge controller is responsible for at least apart of processing for realizing the automatic operation of the edge system 108, and thus an increase in complexity tends to occur in terms of hardware and/or software. For example, examples of the increase in hardware complexity include a case where a GPU, field-programmable gate array (FPGA), a neural network dedicated processor, and other machine learning acceleration hardware are included for the introduction of machine learning processing and the introduction of the processing of recognizing and determining data input from various sensors and cameras in real time.

The diagnostic control unit 113 is a diagnostic controller controlling the diagnosis of the edge system 108. Physical resources such as the processor and the memory of the diagnostic controller are configured separately from and independently of the in-edge controller. By adopting this configuration, the processing load of the in-edge controller is reduced.

The diagnostic control unit 113 as a diagnostic controller and the recognition calculation unit 112 and the actuator control unit 115 as in-edge controllers are connected to the data communication network 110 and communicate via the data communication network 110. In a case where the edge system 108 is a vehicle, it is conceivable that an on board diagnosis 2nd generation (OBD2) diagnostic machine (hereinafter, also referred to as “OBD2 diagnostic machine”) can be connected via a connector to the data communication network 110 as an in-vehicle network. In a case where the recognition calculation unit 112 or the actuator control unit 115 is an ECU capable of communicating with the OBD2 diagnostic machine, the diagnostic control unit 113 may acquire information via the OBD2 diagnostic machine from the recognition calculation unit 112 or the actuator control unit 115.

The diagnostic control unit 113 has a diagnostic data interface 116, an in-device communication processing unit 114, a diagnostic memory map 117, a sequence update processing unit 118, a diagnostic sequence control processing unit 119, and a sequence memory 120.

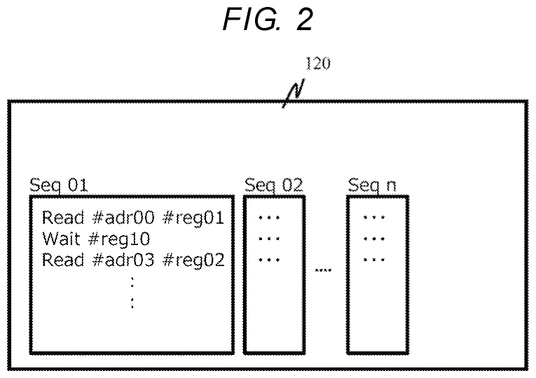

FIG. 2 is a diagram illustrating the data configuration of the sequence memory in Example 1. In Example 1, a plurality of designatable diagnostic sequence sets are pre-stored as a library in the sequence memory 120. In the example of FIG. 2, n diagnostic sequence sets Seq01-n are stored in the sequence memory 120. The diagnostic sequence set is definition information defining a series of procedures through which state data of the edge system 108 is acquired.

In the diagnostic sequence set, which state information is to be acquired and the timing of the acquisition are set with regard to each state information acquired by the diagnostic sequence operating in each in-edge controller. The timing is defined by, for example, a polling cycle.

For example, as a diagnostic sequence in which in-vehicle network communication-related diagnosis is performed, it is conceivable that the in-edge controller performs communication on the data communication network 110, performs packet loss counting, and calculates the error rate per unit time. As a diagnostic sequence in which microcomputer diagnosis is performed, it is conceivable to determine the presence or absence of a core abnormality by inter-core comparison of the results of processing of the plurality of cores included in the CPU of the in-edge controller. The result of the inter-core processing result comparison is stored in a register outside the core, and thus the diagnostic control unit 113 reads the comparison result from the register at a predetermined cycle. Also conceivable is a diagnostic sequence such as diagnosis of various sensors and memory check.

The plurality of diagnostic sequence sets stored in the sequence memory 120 have different settings, and the diagnostic sequence set applied to the edge system 108 can be updated by changing the designated diagnostic sequence set.

The diagnostic sequence control processing unit 119 designates the diagnostic sequence set to be applied with a pointer and acquires state information indicating the state of the hardware of each unit configured in the edge system 108 (one of the internal states of an in-edge controller 10) from the recognition calculation unit 112 and the actuator control unit 115 via the diagnostic data interface 116 in accordance with the designated diagnostic sequence set.

The diagnostic sequence control processing unit 119 generates diagnostic data by mapping the state information acquired from each unit to the diagnostic memory map 117. The diagnostic sequence control processing unit 119 may acquire information indicating the state of the recognition calculation unit 112 and/or the actuator control unit 115 by monitoring the recognition calculation unit 112 and/or the actuator control unit 115 (control program to be more specific) and include the information in the diagnostic data as in the case of the information indicating the internal state of the in-edge controller.

The in-device communication processing unit 114 transmits the diagnostic data stored in the diagnostic memory map 117 to the diagnostic cloud server 104. The in-device communication processing unit 114 receives the notification of the diagnostic sequence or the diagnostic sequence set from the diagnostic cloud server 104 and delivers the notification to the sequence update processing unit 118.

The sequence update processing unit 118 updates the diagnostic sequence set on the sequence memory 120 based on the notified diagnostic sequence set or updates the part of the diagnostic sequence set on the sequence memory 120 that corresponds to the notified diagnostic sequence based on the notified diagnostic sequence. After the diagnostic sequence on the sequence memory 120 is updated, the diagnostic sequence set executed by the diagnostic sequence control processing unit 119 is a post-update set.

### <Manufacturing Company Server>

The manufacturing company server 101 has an edge function update content generation processing unit 102 and a function update instruction processing unit 103.

The edge function update content generation processing unit 102 determines update content when the function of the in-edge controller is updated.

The function update instruction processing unit 103 generates function update information including information on the update content determined by the edge function update content generation processing unit 102 and transmits the function update information to the diagnostic cloud server 104 together with a function update instruction.

### <Diagnostic Cloud Server>

The diagnostic cloud server 104 is a device managing edge system diagnostic content and update thereof and has a state diagnosis processing unit 105, a factor analysis processing unit 106, and a diagnostic processing update instruction unit 107.

The state diagnosis processing unit 105 classifies the state information included in the diagnostic data received from the edge system 108 based on the degrees of importance in accordance with the diagnostic codes thereof and delivers the state information having a predetermined degree of importance or higher to the factor analysis processing unit 106.

The factor analysis processing unit 106 performs factor analysis on the state information delivered from the state diagnosis processing unit 105, identifies what occurred in the edge system 108, an abnormal factor to be specific, and notifies the diagnostic processing update instruction unit 107 and the manufacturing company server 101 of the result of the analysis. The analysis result of the factor analysis is used for function update determination in the manufacturing company server 101.

The factor analysis may be, for example, rule-based abnormal factor identification from the state information. The analysis rule is information defining the chain relationship of abnormalities, that is, the chain relationship of abnormal states occurring in a chain based on the causal relationship of abnormalities. The analysis rule may be generated based on design data 13 or a diagnostic model. Accordingly, the analysis rule may be generated by the manufacturing company server 101 and transmitted to the factor analysis processing unit 106 of the diagnostic cloud server 104. The diagnostic cloud server 104 may generate the analysis rule with the diagnostic cloud server 104 notified of the design data and diagnostic model of the edge system 108 by the manufacturing company server 101.

The diagnostic processing update instruction unit 107 determines the update of every diagnostic sequence or a part of the diagnostic sequence set as needed based on the analysis result and determines the type of state information to be acquired as diagnostic data after the update and the timing at which the state information should be acquired. The diagnostic processing update instruction unit 107 sends a diagnostic update notification designating a post-update diagnostic sequence set to the diagnostic control unit 113 in the edge system 108 to instruct diagnostic sequence set update.

The diagnostic processing update instruction unit 107 determines the update of every diagnostic sequence or a part of the diagnostic sequence set as needed based on the update of the function of the in-edge controller in the edge system 108 by the manufacturing company server 101 and determines the type of state information to be acquired as diagnostic data after the update and the timing at which the state information should be acquired. In that case as well, the diagnostic processing update instruction unit 107 sends a diagnostic update notification designating a post-update diagnostic sequence set to the diagnostic control unit 113 in the edge system 108 to instruct diagnostic sequence set update.

### <Inter-device Cooperation in Distributed System>

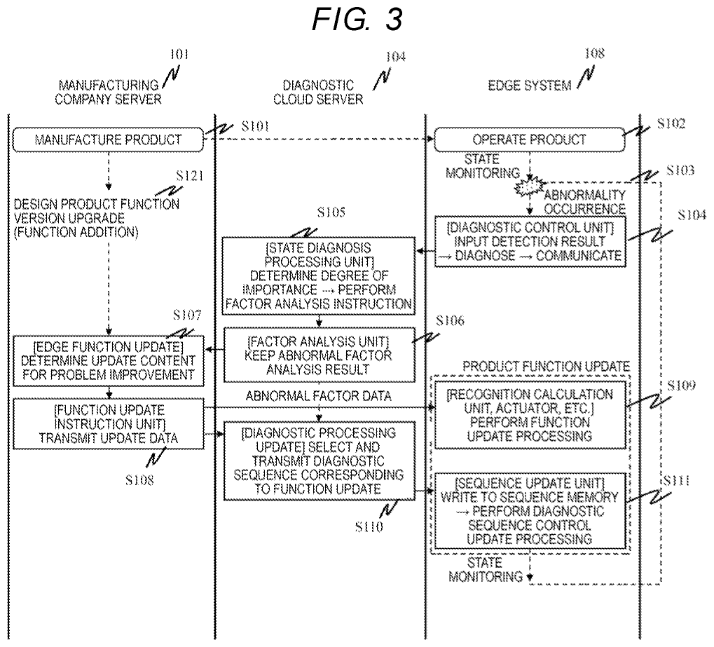

FIG. 3 is a sequence diagram illustrating the flow of the processing of updating the diagnostic sequence set in Example 1.

(Step S101) The edge system 108 is designed and manufactured by a manufacturing company using the manufacturing company server 101.

(Step S102) The edge system 108 manufactured by the manufacturing company is handed over to a user and operation is started. During the operation of the edge system 108, the recognition calculation unit 112 performs state monitoring based on sensor data input from the sensor unit 111.

(Step S103) In the event of any abnormality in the edge system 108, the diagnostic control unit 113 detects the occurrence of the abnormality. For example, in the event of a communication error in the edge system 108, the diagnostic control unit 113 detects the occurrence of the communication error. Other conceivable examples of the abnormality include inter-ECU cable disconnection, the occurrence of packet loss attributable to an excessive amount of communication on the data communication network 110, and garbled memory data.

(Step S104) With the occurrence of the abnormality detected, the diagnostic control unit 113 generates diagnostic data by executing diagnosis in accordance with the diagnostic sequence set and notifies the diagnostic cloud server 104 of the diagnostic data. When an abnormality actually occurs, a plurality of places are likely to become abnormal. In such a case, the diagnostic cloud server 104 is notified of a diagnostic code as diagnostic data indicating the abnormality at the plurality of places by diagnosis.

(Step S105) In the diagnostic cloud server 104, the state diagnosis processing unit 105 adds a degree of importance to the abnormal state indicated by the diagnostic code included in the diagnostic data and, as needed, instructs the factor analysis processing unit 106 to implement factor analysis. The degree of importance with respect to the diagnostic code may be determined in advance by a degree of seriousness obtained from experience. A diagnostic code identified in terms of factor and resolved in the past is set to have a low degree of importance as the necessity of factor analysis is low.

(Step S106) With the instruction received, the factor analysis processing unit 106 performs abnormal factor identification by performing factor analysis, performs record keeping on the analysis result including the abnormality and the factor thereof as abnormal factor data, and notifies the manufacturing company server 101. In the factor analysis, the factor of which part of the edge system 108 is abnormal and how the part is abnormal is determined by, for example, a rule-based determination logic in order from a diagnostic code with a high degree of importance. In another example, the factor determination may be limited to a diagnostic code having a certain degree of importance or higher. The notification to the manufacturing company server 101 may be real-time processing or batch processing.

(Step S107) In the manufacturing company server 101, the edge function update content generation processing unit 102 determines the content of function update for improving the problem of the edge system 108 based on the analysis result notified from the diagnostic cloud server 104 and, as needed, based on determination by a designer. For example, the function update is performed with respect to a control program controlling the amount of throttle valve opening and closing and an image processing program performing image recognition such as white line recognition from a camera image for automatic traveling.

(Step S108) The function update instruction processing unit 103 transmits function update information indicating that the function is to be updated and the function update content to the edge system 108 and the diagnostic cloud server 104.

(Step S109) The edge system 108 receives the function update information, and the in-edge controller including the recognition calculation unit 112 and the actuator control unit 115 performs function update based on the update data.

(Step S110) The diagnostic cloud server 104 receives the function update information, the sequence update processing unit 118 determines a diagnostic sequence corresponding to the function update based on the function update information and the abnormal factor data that is the basis of the function update indicated in the function update information. A diagnostic update notification designating a diagnostic sequence set including the diagnostic sequence is transmitted to the edge system 108. Conceivable examples of the content of the diagnostic update include an increase in the frequency of acquiring state information related in type to the abnormal factor.

(Step S111) In the edge system 108, the sequence update processing unit 118 updates the applied diagnostic sequence set by changing the designation destination of the pointer to the diagnostic sequence set designated by the received diagnostic update notification.

If the function update in Step S109 and the diagnostic sequence set update in Step S111 need to be synchronized, the updates are applied simultaneously. If the synchronization is unnecessary, the function and the diagnostic sequence set may be updated sequentially. At that time, either the function or the diagnostic sequence set may be updated first.

With the function and/or diagnostic sequence set updated, the edge system 108 continues with operation and state monitoring using a new function and/or diagnostic sequence set.

(Step S121) In the manufacturing company server 101, function improvement or addition that is not attributable to an abnormal factor analysis result may be performed. In that case as well, the process may proceed to Step S107 to perform function update and diagnostic sequence update corresponding thereto.

In Step S107 in that case, the edge function update content generation processing unit 102 determines function update content for improvement or addition in terms of the function of the edge system 108 based on determination by a designer as needed.

### <Hardware Configuration of Server>

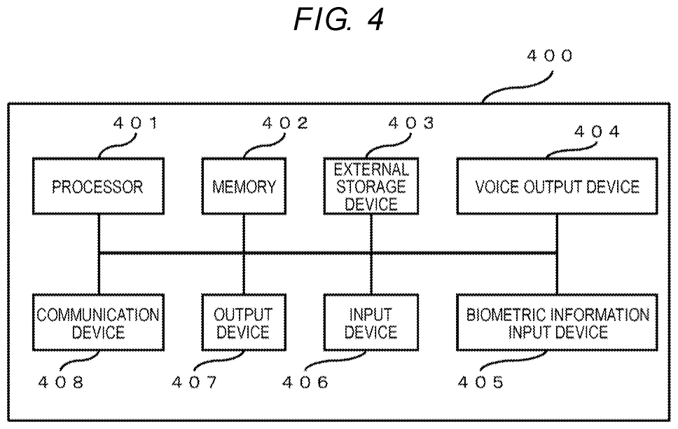

FIG. 4 is a diagram illustrating an example of the hardware configuration of a computer 400 configured in a server. The server referred to here includes the manufacturing company server 101 and the diagnostic cloud server 104. The computer is a device, and thus the computer may be referred to as a computer device.

The computer 400 is configured to include a processor 401 such as a CPU, a memory 402 as a main storage device, an external storage device 403 such as a hard disk and a solid state drive (SSD), a voice output device 404 such as a speaker, a biometric information input device 405 such as a camera, a line-of-sight input device, and a microphone, an input device 406 such as a keyboard, a mouse, and a touch panel, an output device 407 such as a display and a printer, a communication device 408 such as a network interface card (NIC), and a bus connecting these components. Not all of these components are essential.

The memory 402 is, for example, a memory such as a random access memory (RAM).

The external storage device 403 is a non-volatile storage device capable of storing digital information, examples of which include a so-called hard disk, an SSD, and a flash memory.

The communication device 408 is a wired communication device performing wired communication via a network cable or a wireless communication device performing wireless communication via an antenna. The communication device 408 communicates with another device connected to the same network. Although packet communication by a transmission control protocol/Internet protocol (TCP/IP) is adopted for the communication, the communication is not limited thereto and communication by another protocol such as a user datagram protocol (UDP) may be adopted.

The communication device 408 realizes a communication unit (not illustrated) communicably connected to a local area network (LAN) or the like.

Although the above is a hardware configuration example of the computer 400 configured in the server in the present embodiment, the configuration of the computer 400 is not limited thereto and the computer 400 may be configured using other hardware. The computer 400 may be various information processing devices such as a server computer, a personal computer, a laptop personal computer, a tablet device, a smartphone, and a television device.

The computer 400 may have a known program (not illustrated) such as an operating system (OS), middleware, and an application. Such a program is executed by the processor 401 similarly to another program, and the computer 400 performs predetermined processing as a result. The components described by the name of “unit” in each server of the present specification may be realized by the program described above. The processor 401 is not limited to a CPU and may be realized by another processor such as a GPU and an FPGA.

The functional boundary between the memory 402 and the external storage device 403 is ambiguous as a result of technologies such as virtualization. Accordingly, no strict distinction is required insofar as use as a storage resource is possible. The concept including the processor, the storage resource, and the communication device 408 is sometimes referred to as a cloud resource. The cloud can be regarded as a data center as a whole. In this case, a network switch, a router, a data center power supply, and cooling equipment may also be regarded as parts of the cloud resource. The computer 400 may be a virtual entity such as a virtual machine in which the hardware of the physical computer 400 is virtualized.

Input and output devices may be omitted in a computer for a server such as the Web. In this case, substitution is performed by the input of the input device of another computer for a client (client computer) connected to the server computer being received as input data by the computer for server use using the communication device 408. Likewise, the computer for server use transmits data to be output to the client computer using the communication device 408 and performs output using the output data to the output device of the client computer. Regardless of the presence or absence of the input device and the output device, the common point is that input data is received and output processing is performed by a program executed by a computer for server use. In a Web application using the HyperText Markup Language (HTML) and JavaScript, a text to be displayed on an output device is generated by executing the HTML and JavaScript on a client computer executing a web browser. In this case, “output processing” includes the transmission processing of HTML data and JavaScript data by a Web server program executed by a computer for Web server use.

### Example 2

In Example 2, a configuration updating a procedure in which an automatically operable edge system is diagnosed will be described as in Example 1. The distributed system of Example 2 is similar in basic configuration to the distributed system of Example 1. However, unlike the distributed system of Example 1, the distributed system of Example 2 has the function of performing a diagnostic sequence set simulation test on a diagnostic cloud server. In addition, unlike the distributed system of Example 1, the distributed system of Example 2 is capable of adding a new diagnostic sequence set from the diagnostic cloud server to a diagnostic control unit of the edge system.

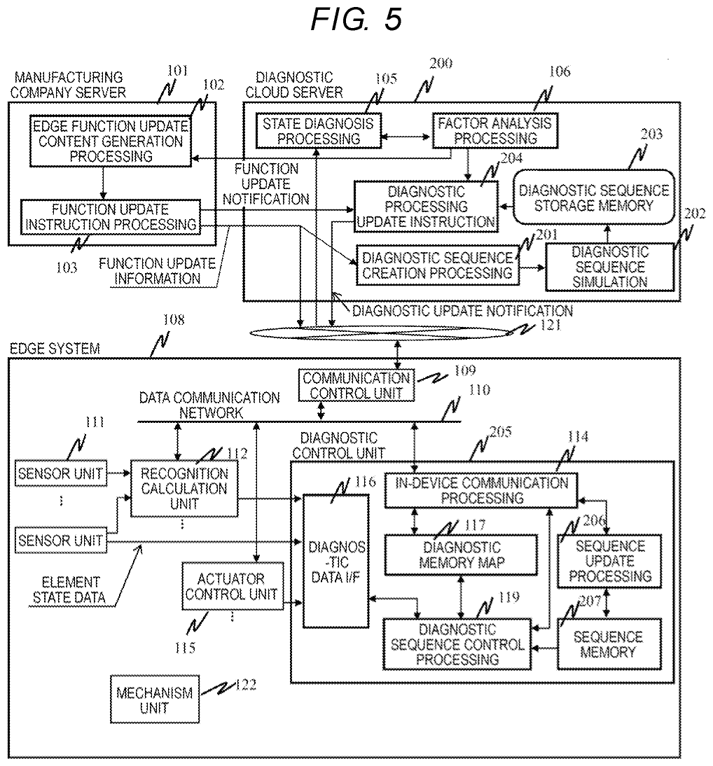

FIG. 5 is a block diagram of the distributed system according to Example 2. In Example 2, the diagnostic cloud server and the diagnostic control unit in the edge system are different from those of Example 1.

Referring to FIG. 5, a diagnostic cloud server 200 according to Example 2 has the state diagnosis processing unit 105, the factor analysis processing unit 106, a diagnostic sequence creation processing unit 201, a diagnostic sequence simulation unit 202, a diagnostic sequence storage memory 203, and a diagnostic processing update instruction unit 204. The state diagnosis processing unit 105 and the factor analysis processing unit 106 are similar to those of Example 1.

Referring to FIG. 5, a diagnostic control unit 205 according to Example 2 has the in-device communication processing unit 114, the diagnostic data interface 116, the diagnostic memory map 117, the diagnostic sequence control processing unit 119, a sequence update processing unit 206, and a sequence memory 207. The in-device communication processing unit 114, the diagnostic data interface 116, the diagnostic memory map 117, and the diagnostic sequence control processing unit 119 are similar to those of Example 1.

The diagnostic sequence creation processing unit 201 determines the update of every diagnostic sequence or a part of the diagnostic sequence set as needed based on the update of the function of the in-edge controller in the edge system 108 by the manufacturing company server 101. The diagnostic sequence creation processing unit 201 determines the type of state information to be acquired as diagnostic data after the update and the timing at which the state information should be acquired and creates a post-update diagnostic sequence set based on the type of the state information and the timing.

In the diagnostic cloud server 200, the data configuration of the sequence memory 207 is different from that of Example 1.

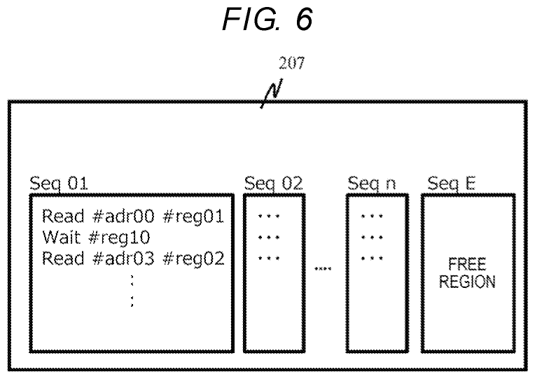

FIG. 6 is a diagram illustrating the data configuration of the sequence memory 207 in Example 2. In Example 2, the plurality of designatable diagnostic sequence sets Seq01-n are pre-stored in the sequence memory 120 and there is a free region where a new diagnostic sequence set SeqE can be additionally stored. The free region may be provided as a configuration of the sequence memory 207 in Example 1 as well, and then a new diagnostic sequence can be written from the diagnostic cloud server 104.

The diagnostic sequence simulation unit 202 simulates the recognition calculation unit 112 and the actuator control unit 115 of the edge system 108 and performs a simulation test of the post-update diagnostic sequence set. At this time, the diagnostic sequence simulation unit 202 confirms, for example, that a desired type of state information is acquired at a desired timing with regard to the post-update diagnostic sequence set.

In a case where a software program realizing a post-update function (hereinafter, also referred to as a function program) is applied to the recognition calculation unit 112 or the actuator control unit 115 for the function to be updated, the function program may be transmitted from the manufacturing company server 101 to the diagnostic cloud server 104 so that the recognition calculation unit 112 or the actuator control unit 115 is simulated. In that case, the diagnostic cloud server 104 may simulate the recognition calculation unit 112 or the actuator control unit 115 based on the received function program.

In the event of a normal simulation test result, the diagnostic sequence simulation unit 202 stores data of the tested diagnostic sequence set in the diagnostic sequence storage memory 203.

The diagnostic processing update instruction unit 204 instructs diagnostic sequence set update by sending the post-update diagnostic sequence set stored in the diagnostic sequence storage memory 203 and a diagnostic update notification designating the post-update diagnostic sequence set to the diagnostic control unit 205 in the edge system 108.

In the diagnostic control unit 205 of the edge system 108, the sequence update processing unit 206 stores the post-update diagnostic sequence set in the free region of the sequence memory 207 and changes the designation destination to the post-update diagnostic sequence set when the diagnostic sequence set update instruction is received from the diagnostic cloud server 200.

The examples described above include the following items. Items included in the examples described above are not limited to the followings.

### (Item 1)

A distributed system including:

an edge system as an automatically operable moving body or equipment; and

a diagnostic data computer capable of communicating with the edge system, in which

the edge system has a mechanism unit for operation, an in-edge controller controlling the mechanism unit, and a diagnostic controller capable of communicating with the in-edge controller via an in-vehicle network,

the diagnostic controller:

acquires diagnostic data in accordance with a first diagnostic sequence set indicating a procedure in which the in-edge controller is diagnosed by one or more diagnostic sequences defining an information type and a timing acquired as diagnostic data indicating an internal state of the in-edge controller, and

transmits the acquired diagnostic data to the diagnostic data computer,

the diagnostic data computer:

determines an information type and a timing to be acquired as diagnostic data from the in-edge controller based on the received diagnostic data, and

transmits a diagnostic update notification of update to a second diagnostic sequence set including a diagnostic sequence defining the determined information type and timing to the diagnostic controller, and

the diagnostic controller:

performs update from the first diagnostic sequence set to the second diagnostic sequence set,

acquires diagnostic data in accordance with the second diagnostic sequence set, and

transmits the acquired diagnostic data to the diagnostic data computer.

According to this, the quality of diagnosis can be improved by diagnostic data-based diagnostic sequence set update and the load on an in-vehicle device can be reduced by providing the diagnostic controller separately from the in-edge controller.

### (Item 2)

The distributed system according to Item 1, further including a computer for a manufacturing company owned by a company manufacturing the edge system and capable of communicating with the diagnostic data computer, in which

the computer for the manufacturing company:

generates function update information for updating a function of the in-edge controller, and

transmits the function update information to the in-edge controller and the diagnostic data computer,

the in-edge controller performs function update in accordance with the function update information,

the diagnostic data computer:

determines an information type and a timing to be acquired as diagnostic data from the in-edge controller based on the function update information, and

transmits a diagnostic update notification to a third diagnostic sequence set including a diagnostic sequence defining the determined information type and timing to the diagnostic controller, and

the diagnostic controller:

performs change from the first diagnostic sequence set to the third diagnostic sequence set and acquires diagnostic data.

According to this, diagnosis matching the updated function of the in-edge controller can be performed by function update information-based diagnostic sequence set update.

### (Item 3)

The distributed system according to Item 2, in which

the diagnostic data computer:

performs factor analysis processing of a state of the in-edge controller based on the diagnostic data, and

transmits factor analysis result data obtained by the factor analysis processing to the computer for the manufacturing company, and

the computer for the manufacturing company generates the function update information based on the factor analysis result data.

According to this, the function of the in-edge controller is updated based on the result of the factor analysis, the diagnostic sequence set is updated based on the function update information, and thus diagnosis matching the updated function of the in-edge controller can be performed.

### (Item 4)

The distributed system according to Item 1, in which the diagnostic data computer transmits the diagnostic update notification to the second diagnostic sequence set to the diagnostic controller after performing a simulation test of the second diagnostic sequence set.

According to this, the diagnostic sequence set simulation test is performed and then applied to the edge system, and thus the diagnostic sequence set can be updated with safety.

### (Item 5)

The distributed system according to Item 1, in which the diagnostic controller:

includes a sequence memory storing, in a designatable manner, data of a plurality of diagnostic sequence sets including the first diagnostic sequence set and the second diagnostic sequence set, and

performs change from the first diagnostic sequence set to the second diagnostic sequence set by changing a designation destination in the sequence memory.

According to this, the plurality of diagnostic sequence sets are preset, which diagnostic sequence set to use can be designated by a pointer, and thus the diagnostic sequence set can be updated with ease.

(Item 6)

The distributed system according to Item 5, in which

the sequence memory has a free region where a diagnostic sequence set is addable,

the diagnostic data computer transmits a diagnostic update notification to a fourth diagnostic sequence set including a diagnostic sequence defining the determined information type and timing and not stored in the sequence memory to the diagnostic controller, and

the diagnostic controller:

records data of the fourth diagnostic sequence set in the free region, and

performs change from the first diagnostic sequence set to the fourth diagnostic sequence set by changing the designation destination in the sequence memory.

According to this, update to a diagnostic sequence set that is not pre-stored in the sequence memory can be performed.

### (Item 7)

The distributed system according to Item 1, in which

the edge system is an automobile, and

the in-edge controller is an electronic control unit.

According to this, the load on a low-processing capacity automotive ECU that is attributable to diagnosis execution can be reduced.

The examples described above are examples for describing the present invention, and it is not intended to limit the scope of the present invention to the examples. Those skilled in the art can implement the present invention in various other aspects without departing from the scope of the present invention.

What is claimed is:

1. A distributed system comprising:
an edge system as an automatically operable moving body or equipment; and
a diagnostic data computer capable of communicating with the edge system, wherein
the edge system has a mechanism unit for operation, an in-edge controller controlling the mechanism unit, and a diagnostic controller capable of communicating with the in-edge controller via an in-vehicle network,
the diagnostic controller:
acquires diagnostic data in accordance with a first diagnostic sequence set indicating a procedure in which the in-edge controller is diagnosed by one or more diagnostic sequences defining an information type and a timing acquired as diagnostic data indicating an internal state of the in-edge controller, and
transmits the acquired diagnostic data to the diagnostic data computer,
the diagnostic data computer:
determines an information type and a timing to be acquired as diagnostic data from the in-edge controller based on the received diagnostic data, and
transmits a diagnostic update notification of update to a second diagnostic sequence set including a diagnostic sequence defining the determined information type and timing to the diagnostic controller, and
the diagnostic controller:
performs update from the first diagnostic sequence set to the second diagnostic sequence set,
acquires diagnostic data in accordance with the second diagnostic sequence set, and
transmits the acquired diagnostic data to the diagnostic data computer.

2. The distributed system according to claim 1, further comprising a computer for a manufacturing company owned by a company manufacturing the edge system and capable of communicating with the diagnostic data computer, wherein
the computer for the manufacturing company:
generates function update information for updating a function of the in-edge controller, and
transmits the function update information to the in-edge controller and the diagnostic data computer,
the in-edge controller performs function update in accordance with the function update information,
the diagnostic data computer:
determines an information type and a timing to be acquired as diagnostic data from the in-edge controller based on the function update information, and
transmits a diagnostic update notification to a third diagnostic sequence set including a diagnostic sequence defining the determined information type and timing to the diagnostic controller, and
the diagnostic controller:
performs change from the first diagnostic sequence set to the third diagnostic sequence set and acquires diagnostic data.

3. The distributed system according to claim 2, wherein
the diagnostic data computer:
performs factor analysis processing of a state of the in-edge controller based on the diagnostic data, and
transmits factor analysis result data obtained by the factor analysis processing to the computer for the manufacturing company, and
the computer for the manufacturing company generates the function update information based on the factor analysis result data.

4. The distributed system according to claim 1, wherein the diagnostic data computer transmits the diagnostic update notification to the second diagnostic sequence set to the diagnostic controller after performing a simulation test of the second diagnostic sequence set.

5. The distributed system according to claim 1, wherein the diagnostic controller:
includes a sequence memory storing, in a designatable manner, data of a plurality of diagnostic sequence sets including the first diagnostic sequence set and the second diagnostic sequence set, and
performs change from the first diagnostic sequence set to the second diagnostic sequence set by changing a designation destination in the sequence memory.

6. The distributed system according to claim 5, wherein
the sequence memory has a free region where a diagnostic sequence set is addable,
the diagnostic data computer transmits a diagnostic update notification to a fourth diagnostic sequence set including a diagnostic sequence defining the determined information type and timing and not stored in the sequence memory to the diagnostic controller, and
the diagnostic controller:
records data of the fourth diagnostic sequence set in the free region, and
performs change from the first diagnostic sequence set to the fourth diagnostic sequence set by changing the designation destination in the sequence memory.

7. The distributed system according to claim 1, wherein
the edge system is an automobile, and
the in-edge controller is an electronic control unit.

8. A diagnostic method for diagnosing an edge system in a distributed system including the edge system as an automatically operable moving body or equipment and a diagnostic data computer capable of communicating with the edge system having a mechanism unit for operation, an in-edge controller controlling the mechanism unit, and a diagnostic controller capable of communicating with the in-edge controller via an in-vehicle network, wherein
the diagnostic controller:
acquires diagnostic data in accordance with a first diagnostic sequence set indicating a procedure in which the in-edge controller is diagnosed by one or more diagnostic sequences defining an information type and a timing acquired as diagnostic data indicating an internal state of the in-edge controller, and
transmits the acquired diagnostic data to the diagnostic data computer,
the diagnostic data computer:
determines an information type and a timing to be acquired as diagnostic data from the in-edge controller based on the received diagnostic data, and
transmits a diagnostic update notification of update to a second diagnostic sequence set including a diagnostic sequence defining the determined information type and timing to the diagnostic controller, and
the diagnostic controller:
performs update from the first diagnostic sequence set to the second diagnostic sequence set,
acquires diagnostic data in accordance with the second diagnostic sequence set, and
transmits the acquired diagnostic data to the diagnostic data computer.
